(19) United States
(12) Patent Application Publication
(10) Pub. No.: US 2025/0050644 A1
(43) Pub. Date: Feb. 13, 2025

(54) APPARATUS FOR STORING AND/OR SUPPLYING INK TO AN INKJET PRINTHEAD

(71) Applicant: Cryovac, LLC, Charlotte, NC (US)

(72) Inventors: Anthony Vincent Moscato, N. Tonawanda, NY (US); George A. Alessi, Buffalo, NY (US); Kent D. Jayme, Grand Island, NY (US); Theodore F. Cyman, Grand Island, NY (US)

(21) Appl. No.: 18/722,766

(22) PCT Filed: Dec. 22, 2022
(86) PCT No.: PCT/US2022/053756

§ 371 Date: Jun. 21, 2024

Related U.S. Application Data
(60) Provisional application No. 63/293,178, filed on Dec. 23, 2021.

(51) Int. Cl. B41J 2/175

(52) U.S. Cl. CPC B41J 2/17513

(57) ABSTRACT

A fluid container (1400) comprises a main member (1402), upper and lower plates (1404, 1406) secured to upper and lower portions of the main member (1402), respectively, and a central rod (1414) extending through the upper plate (1404). A hollow stirrer bar (1420) is rotatably coupled to the central rod (1414) and is disposed in a space between the upper and lower plates (1404, 1406) and at least one first magnet is disposed in the stirrer bar (1420). An inlet tube (1450) and an outlet tube (1452) extend into the main member (1402). A holder (1403) is disposed outside of the space between the upper and lower plates (1404, 1406) having at least one movable second magnet magnetically linked with the at least one first magnet, wherein movement of the at least one second magnet causes rotation of the stirrer bar (1420). A modular ink supply unit is also disclosed.

### CROSS REFERENCE TO RELATED APPLICATION

The present application claims the benefit of U.S. Provisional Patent Application Ser. No. 63/293,178, filed on Dec. 23, 2021, and entitled “APPARATUS FOR STORING AND/OR SUPPLYING INK TO AN INKJET PRINTHEAD.” The entire contents of this application are incorporated herein by reference.

### FIELD OF DISCLOSURE

The present subject matter disclosed herein generally relates to inkjet printing systems, and more particularly, to a system and method for storing and/or supplying ink to one or more inkjet printheads used by such systems.

### BACKGROUND

High-speed printing systems typically include one or more imaging units. Each imaging unit has one or more inkjet printheads and a controller controls each inkjet printhead to eject a fluid (such as ink or another composition) onto a receiving surface. Each inkjet printhead includes a nozzle plate that includes a plurality of orifices (nozzles) through which ink from inside the inkjet printhead may be controllably ejected.

Ink is supplied to each inkjet printhead from an ink reservoir via an ink line. If air becomes trapped in the ink line and flows into the fluid chamber of the inkjet printhead during printing, such air may interfere with the proper ejection of ink from the nozzles of the inkjet printhead.

Also, aqueous ink compositions for inkjet printing typically include colorant particles suspended in an aqueous fluid carrier comprising water, surfactants, solvents, and the like. The particles tend to fall out of suspension, resulting in problems with printhead operation and print quality. Such inks must accordingly be kept in motion and/or periodically agitated to prevent the particulates from falling out of suspension.

The discussion above is merely provided for general background information and is not intended to be used as an aid in determining the scope of the claimed subject matter.

### SUMMARY

According to one aspect, a fluid container comprises a main member, upper and lower plates secured to upper and lower portions of the main member, respectively, and a central rod extending through the upper plate. A hollow stirrer bar is rotatably coupled to the central rod and is disposed in a space between the upper and lower plates and at least one first magnet is disposed in the stirrer bar. An inlet tube and an outlet tube extend into the main member. A holder is disposed outside of the space between the upper and lower plates and at least one movable second magnet is magnetically linked with the at least one first magnet, wherein movement of the at least one second magnet causes rotation of the stirrer bar.

According to another aspect, a modular ink assembly comprises a first mounting plate having a plurality of mounting stations each adapted to receive and mount a plurality of fluid containers at variable relative elevations and first and second ink reservoirs mounted at one of the mounting stations. A second mounting plate is adjacent the first mounting plate and is adapted to receive and mount ink supply elements. A plurality of restraining members is disposed adjacent the mounting stations wherein each restraining member is adapted to receive a main supply reservoir.

Other aspects and advantages will become apparent upon consideration of the following detailed description and the attached drawings wherein like numerals designate like structures throughout the specification.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a block diagram of an exemplary ink supply system;

FIG. 2 is an isometric view of one of the ink reservoirs 1306, 1308 of FIG. 1;

FIG. 3 is an isometric view of the ink reservoir of FIG. 2;

FIG. 4 is an enlarged fragmentary view, partly in section, of a portion of the reservoir of FIG. 2;

FIG. 5 is an enlarged fragmentary view with portions removed of a portion of the reservoir of FIG. 2;

FIG. 6 is a longitudinal sectional view of the reservoir of FIG. 2;

FIG. 7 is an isometric schematic view of an embodiment of the ink reservoir of FIG. 2;

FIG. 8 is a longitudinal sectional schematic view with some elements omitted of an embodiment of the ink reservoir of FIG. 2;

FIGS. 9 and 11 are views similar to FIG. 8 illustrating embodiments:

FIG. 10 is a sectional view taken generally along the lines 10-10 of FIG. 9;

FIG. 12 is an isometric view of an embodiment;

FIG. 13 is a sectional view taken generally along the lines 13-13 of FIG. 12;

FIG. 14 is an enlarged, sectional, fragmentary view taken generally along the lines 14-14 of FIG. 12.

FIG. 15 is an enlarged, fragmentary, isometric view with portions omitted therefrom of portions of an apparatus for storing and supplying ink to an inkjet printhead according to an embodiment;

FIG. 16 is a fragmentary, front elevational view of the apparatus of FIG. 15 disposed in a housing;

FIG. 17 is an isometric view of the of the apparatus of FIG. 16 with additional ink supply units disposed in the housing; and

FIG. 18 is a sectional view taken generally along the lines 18-18 of FIG. 15.

### DETAILED DESCRIPTION

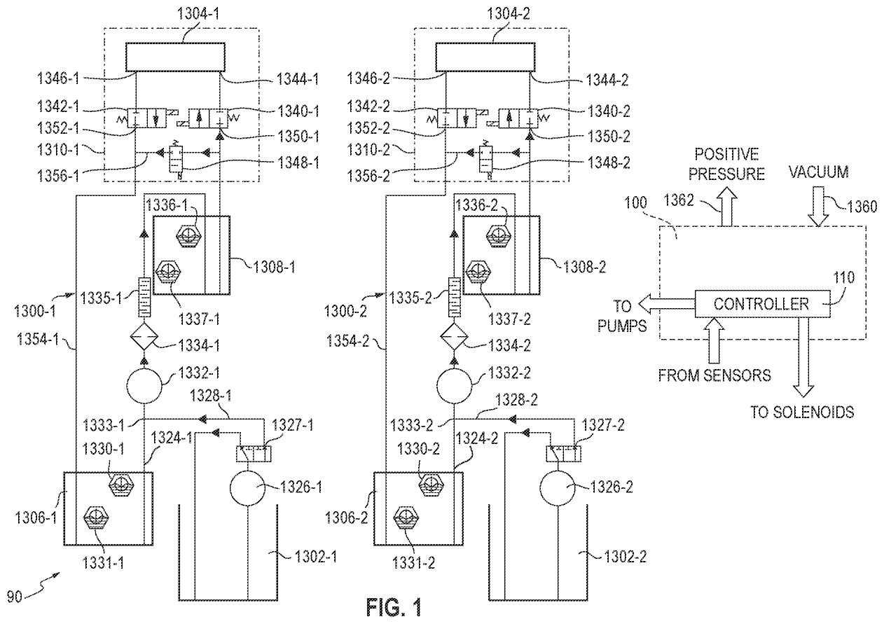

FIG. 1 illustrates an embodiment of an apparatus 90 for storing and supplying ink to an inkjet printhead. As schematically shown in FIG. 1, which illustrates one example of an ink supply unit 1300-1, a main supply reservoir 1302-1 stores and supplies ink to one or more printheads. (For ease of reference, a single printhead 1304-1 is shown in FIG. 1 and reference to “a printhead” hereinafter is to be construed as any one or more of the printheads disclosed in the various embodiments herein. Also, various fluid components are omitted from FIG. 1, such as T-connectors, flow combiners, flow dividers, etc. for simplicity. Still further, no attempt is made in FIG. 1 to arrange elements in any particular physical arrangement.) The ink supply unit 1300-1 includes a first or lower ink reservoir 1306-1, a second or upper ink reservoir 1308-1, and a flow regulation apparatus 1310-1.

As seen in FIG. 1, an ink control 100 comprises a controller 110 that operates solenoid valves and pumps of the ink supply unit 1300-1 to provide ink on demand to the printhead 1304-1. Further, when the printhead 1304-1 does not require ink, the controller operates such valves, pumps, and agitators in the first and second reservoirs 1306-1, 1308-1 as well as the main ink supply 1302-1 to keep the ink substantially constantly in motion, for example, between the ink supply unit 1300-1 and the printhead 1304-1, and/or among and within the main ink supply 1302-1, the first ink reservoir 1306-1, the second ink reservoir 1308-1 and the flow regulation apparatus 1310-1. In particular, ink is kept in motion within the reservoirs 1302-1, 1306-1, 1308-1 even when ink is not being supplied thereto or being withdrawn therefrom. Keeping the ink in motion preserves a relatively even distribution of components, for example, pigment/colorant particles, in the ink, and prevents separation and/or settling of such components.

As illustrated in FIG. 1, a main supply pump 1326-1, when actuated by the controller 110, draws ink from the main supply reservoir 1302-1 and delivers same via a circulation solenoid valve 1327-1 operated by the controller 110 and conduits 1328-1, 1324-1 to the first ink reservoir 1306-1. The first ink reservoir 1306-1 includes high and low level sensors 1330-1, 1331-1, respectively, that develop high and low level signals indicating whether the fluid level in the first ink reservoir 1306-1 is inside or outside of a first predetermined range. The first ink reservoir 1306-1 is fluidically coupled to the second ink fluid reservoir 1308-1 by a circulation pump 1332-1 that is coupled to a junction 1333-1 between the conduits 1328-1, 1324-1, a filter 1334-1, and a degas module 1335-1. The filter 1334-1 traps any impurities or contaminants in the ink. The degas module 1335-1 removes any dissolved air that may be in the ink.

In similar fashion to the first ink reservoir 1306-1, the second ink reservoir 1308-1 includes high and low level sensors 1336-1, 1337-1, respectively, that develop high and low level signals indicating whether the fluid level in the second ink reservoir 1308-1 is inside or outside of a second predetermined range. The high and low level signals developed by the sensors 1330-1, 1331-1, 1336-1, 1337-1 are provided to the controller 110 and the controller 110 operates the various components of the ink supply unit 1300-1 to maintain fluid levels in the first and second ink reservoirs 1306-1, 1308-1 within the first predetermined range and the second predetermined range, respectively.

The second reservoir 1308-1 is fluidically coupled to the flow regulation apparatus 1310-1. The flow regulation apparatus 1310-1 is, in turn, fluidically coupled to the first ink reservoir 1306-1. The flow regulation apparatus includes a supply solenoid valve 1340-1 and a return solenoid valve 1342-1 that are fluidically coupled to inlet and outlet ports 1344-1, 1346-1, respectively, of the printhead 1304-1. A bypass solenoid valve 1348-1 is fluidically coupled across inlet and outlet ports 1350-1, 1352-1 of the supply solenoid valve 1340-1 and the return solenoid valve 1342-1, respectively. A return conduit 1354-1 couples the outlet port 1352-1 and an outlet port 1356-1 of the bypass solenoid valve 1348-1 to the first ink reservoir 1306-1.

If necessary or desirable, one or more other components may be provided at one or more locations in the ink supply unit 1300-1, such as a temperature sensor, pressure sensor, and/or flow sensor, an ink temperature regulator, one or more pressure regulators, and/or flow regulators, another pump and/or valve(s), etc. In an embodiment, the ink control 100 comprises relative sources of negative and positive relative pressures that provide vacuum and positive pressures, for example, over conduits 1360, 1362 to various elements of FIG. 1, such as the first reservoir 1306-1 and the second reservoir 1308-1, respectively. Thus, the first reservoir 1306-1 may be disposed at a different or same physical elevation as the second reservoir 1308-1 and proper operation may be accomplished by controlling the negative and positive relative pressures in the reservoirs 1306-1, 1308-1 and in the flow regulation apparatus 1310-1 in an appropriate fashion responsive to at least one pressure reference signal developed by or supplied to the controller 110.

If desired, one or more of the various elements shown in FIG. 1 may be disposed at another part of the ink supply unit 1300-1.

Under normal operating conditions, with the exception of a conduit 1324-1, even when not using ink, all the conduits in the system and reservoirs have fluid moving and the ink therein is well mixed because of the natural circulation through the printhead 1304-1. This circulation occurs irrespective of whether printing is occurring. However, if there is no printing, and thus no ink being consumed, the ink in the conduit 1324-1 would remain dormant until more ink is needed. In practice, although it is advantageous to keep conduit lengths as short as possible as noted below, the conduit 1324-1 may be relatively long, and allowing ink to remain stagnant in the conduit 1324-1 can be problematic. Accordingly, a flow path is provided back to the main supply reservoir 1302-1 in which ink is circulated without filling or draining either of the reservoirs 1306-1, 1308-1, which is a way in which fluid is kept in motion and therefore well mixed. Flow back to the supply reservoir 1302-1 is accomplished by transferring ink therefrom using the main supply pump 1326-1. The solenoid valve 1327-1 has the ability in response to commands issued by the controller 110 to selectively route fluid to the first reservoir 1306-1 or back to the main supply reservoir 1302-1 as needed to prevent stagnation.

The ink supply unit 1300-1 is effective to print on a substrate using the ink stored in the main ink supply 1302-1. If desired, the ink supply unit 1300-1 may be supplemented by any number of additional ink supply units that may be operated by one or more ink controls, such as the ink control 100, in the fashion described above in connection with the ink supply unit 1300-1. The additional ink supply units may operate printheads that apply inks that are the same as or different than the ink applied by the printhead 1304-1. Thus, for example as also shown in FIG. 1, an ink supply unit 1300-2 may be provided that is identical to the ink supply unit 1300-1, wherein elements in the unit 1300-2 have the same reference numbers as corresponding elements in the ink supply unit 1300-1, with the exception that such reference numerals have the suffix “-2.” The printhead 1304-2 may be spaced from the printhead 1304-1 at a distance and at a position that allows overprinting, printing of spaced images, printing stitching, etc. thereby.

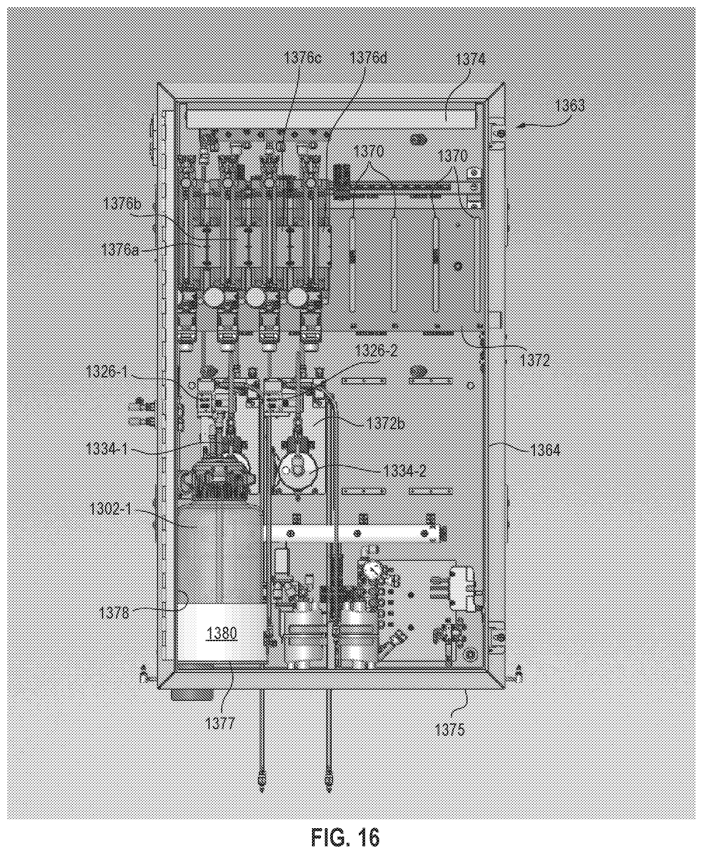

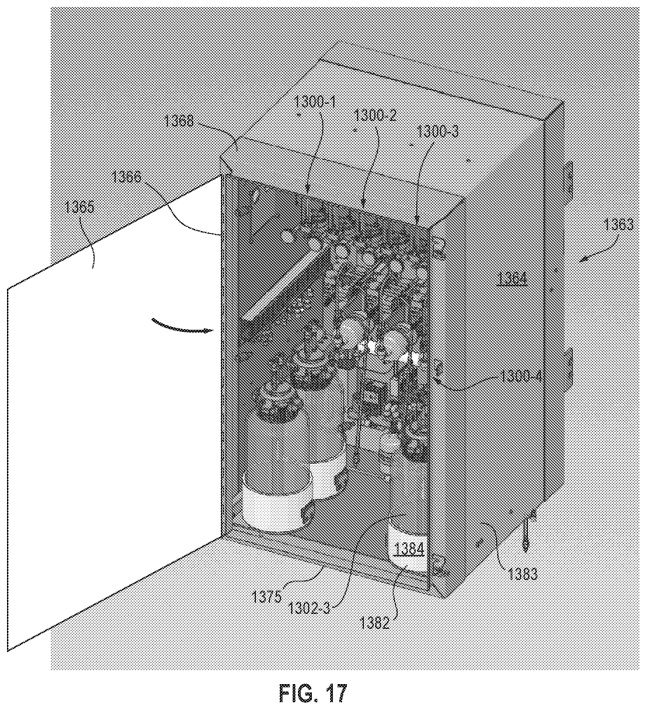

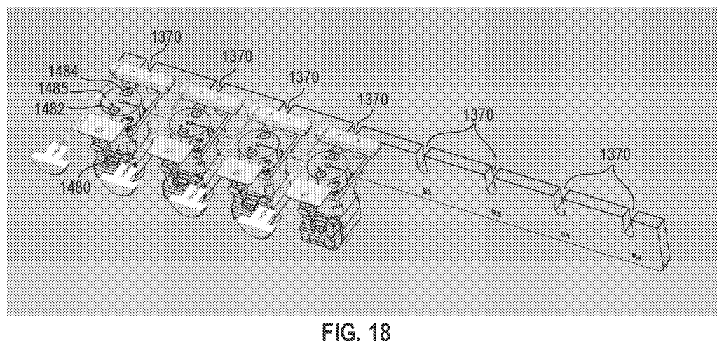

Referring to FIGS. 15-17, a modular ink assembly 1363 is illustrated. Various elements of the ink supply units 1300-1, 1300-2 are disposed in a housing 1364 (seen only in FIGS. 16 and 17). While not completely shown in FIGS. 15-17 for the sake of clarity, the various components disposed in the housing 1364 are fluidically interconnected by the conduits illustrated in FIG. 1. (Four conduits are shown in FIGS. 15-17 as being suspended (i.e., hanging down) from elements illustrated in such FIGS. In the illustrated embodiment, free ends of such conduits are fluidically coupled to the main ink supplies 1302. Also, as shown in FIG. 17, the housing 1364 may include a door 1365 secured to a hinge 1366 so that a closable cabinet 1368 is formed that can accept any one up to a maximum number of ink supply units 1300 therein. In an embodiment, the cabinet 1368 can accept portions of up to four ink supply units 1300 therein, although the maximum number may instead be a different quantity, as necessary or desirable. In the embodiment illustrated in FIGS. 15 and 16, first portions of the two ink supply units are mounted by fasteners or other means in slots 1370 (only some of which are visible in such FIGS.) in a first mounting plate 1372a that is, in turn, secured in any suitable fashion, such as by welds or fasteners, to a rear wall 1374 of the housing 1364. In an embodiment, the slots 1370 are parallel to and equally spaced from one another, are of equal lengths, are equally spaced from a lower surface 1375 of the housing 1364, extend perpendicular to the surface 1375, and have identical widths and other dimensions, although in other embodiments some or all of these conditions need not and/or may not be satisfied. Second portions of the two ink supply units 1300-1, 1300-2 are mounted by fasteners or other means in bores or apertures (not visible) in a second mounting plate 1372b that is, in turn, secured in any suitable fashion, such as by welds or fasteners, to the rear wall 1374 of the housing 1364 and/or suspended from the first mounting plate 1372a.

Specifically, as seen in FIGS. 15 and 16, the two first or lower ink reservoirs 1306-1 and 1306-2 and the two second or upper ink reservoirs 1308-1 and 1308-2 are secured by enclosing frames 1376a-1376d, respectively, to the mounting plate 1372. The enclosing frames 1376 may be secured by separate or integral fasteners that extend through corresponding slots 1370 and the fasteners may comprise bolts that receive washers and nuts that capture and hold the portions of the mounting plate 1372 surrounding the corresponding slots 1370 to rear surfaces of the enclosing frames 1376. Disposition of the fasteners in the slots 1370 results in the ability to locate and adjust the relative heights of the reservoirs 1306, 1308 such that height differential(s) may be established, if necessary or desirable, between the first reservoir(s) 1306-1, 1306-2 and the second reservoir(s) 1308-1, 1308-2, respectively, for proper operation of the ink control 100.

The main supply pump 1326-1, the circulation pump 1332-1, the filter 1334-1, and the degas module 1335-1 are mounted to the second mounting plate 1375 in any suitable fashion, such as by bolts or other fasteners. In like fashion, the main supply pump 1326-2, the circulation pump 1332-2, the filter 1334-2 and the degas module 1335-2 are also mounted to the second mounting plate 1375 in any suitable fashion, such as by bolts or other fasteners. The main supply reservoirs 1302-1 and 1302-2 are disposed on a support plate 1377 that is secured in any suitable fashion, such as by weld(s), bolts, or other fasteners, to a side wall 1378 of the housing 1364. Restraining members 1380, 1381 are secured to the support plate 1377 and/or any other structure in any suitable manner and the main supply reservoirs 1302-1, 1302-2, respectively, are disposed in the members 1380, 1381 and are restrained against movement thereby.

FIG. 17 illustrates the case in which four ink supply units 1300-1, 1300-2, 1300-3, and 1300-4 are accommodated in the housing 1364. The ink supply units 1300-1 through 1300-4 may print the same or different inks as noted previously. In an embodiment, the ink supply units are identical to one another and are mounted in the housing 1364 in identical fashion as described above in connection with FIGS. 15 and 16, with the exception that a main supply reservoir 1302-3 associated with the ink supply unit 1300-3 is supported on a support plate 1382 secured to a side wall 1383 opposite the side wall 1378 and restrained against movement by a restraining member 1384. Although not visible in FIG. 17, a main supply reservoir associated with the ink supply unit 1300-4 is restrained in a restraining member behind the reservoir 1302-3 and the restraining member 1384 in a fashion similar to the main supply reservoir 1302-2 and the restraining member 1381. In the illustrated embodiment, the support plate 1382 and restraining members supported thereby are mirror images of the support plate 1377 and the restraining members 1380, 1381, respectively, although this need not be the case.

As should be evident, the ink assembly 1363 disclosed herein has a modular capability in the sense that a plurality of mounting stations 1386-1, 1386-2, 1386-3, and 1386-4 is provided. Each station 1386 is adapted to receive and mount the first reservoir 1306 and the second reservoir 1308 at variable relative elevations. Further, ink supply elements are disposed adjacent to and in close proximity (ideally, as close as possible) with each other and with the associated first and second reservoirs. In the illustrated embodiment, the ink supply elements comprise two pumps 1326 and 1332, a filter 1334, and a degas module 1335. Further, a main supply reservoir 1302 is disposed adjacent to and in close proximity (ideally, as close as possible) with the associated mounting station 1386. An ink assembly 1363 having a plurality of ink supply units 1300, each of compact size and having relatively short conduit lengths is realized. The relatively short conduit lengths and the operation of the various elements to keep ink in motion result in an advantageous reduction in ink supply and printing problems. As noted previously, a different number of ink supply units 1300 other than the number illustrated in the FIGS. can be accommodated in the housing 1364, such as one or three ink supply units. Flexibility is achieved by the modular nature of the design so that the apparatus 90 can be configured readily for use in different installations having different and/or diverse printing requirements.

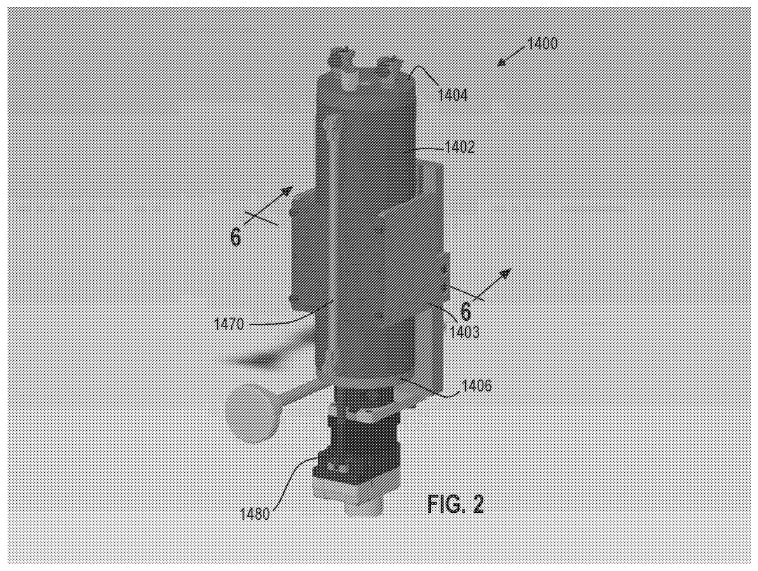

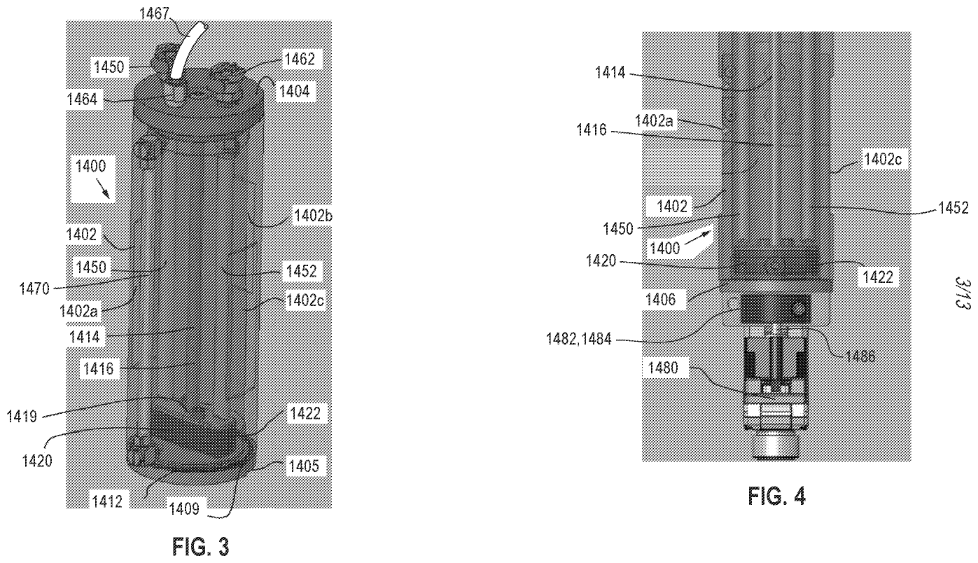

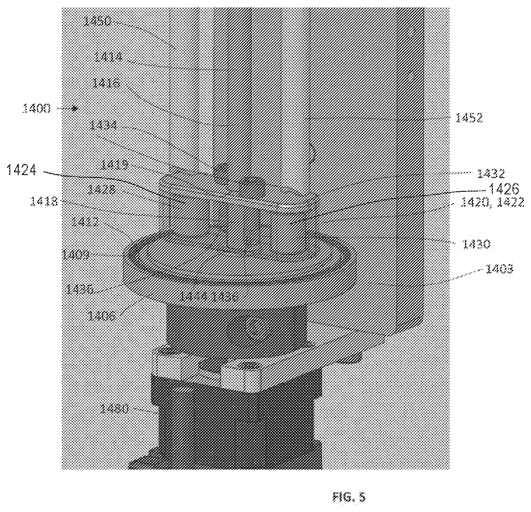

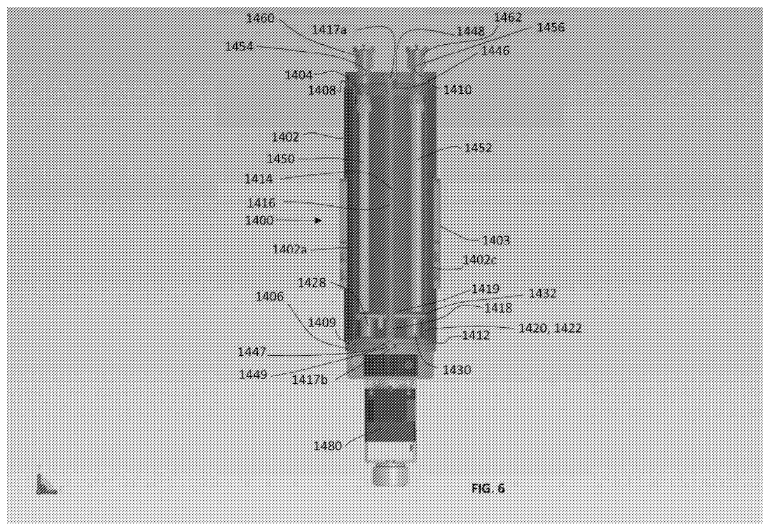

In an embodiment, each of the first reservoirs 1306-1, 1306-2 and other first reservoirs and each of the second reservoirs 1308-1, 1308-2 and other second reservoirs shown in FIGS. 1 and 15-17 comprises the ink or other fluid container 1400 illustrated in FIGS. 2-6. The ink container 1400 includes a generally cylindrical main member 1402 retained in a holder 1403 (seen in FIGS. 2 and 6) comprising each of the enclosing frames 1376a-1376d wherein the holder 1403 engages flat external surfaces 1402a, 1402b, 1402c (best seen in FIG. 3). The ink container 1400 further includes a circular upper plate comprising a cover 1404 and a circular bottom plate comprising a base 1406. Each of the cover 1404 and base 1406 includes a circumferential groove 1408, 1409, respectively, (FIG. 6) that accepts a sealing member, such as an O-ring 1410, 1412. The ink container 1400 further includes a longitudinally-extending stationary central rod 1414 comprising a central portion 1416, upper and lower internally-threaded ends 1417a, 1417b, respectively, (shown in FIG. 6) disposed on either side of the central portion 1416, and a reduced diameter portion 1418 defined by a shoulder 1419 disposed between the central portion 1416 and the lower end.

Although seen only in FIG. 1, upper and lower fluid level sensors comprising the sensors 1330, 1331 are disposed and secured in/on the fluid container 1400 in any suitable fashion.

In the illustrated embodiment, an agitation apparatus is disposed in the container 1400. Specifically, a hollow stirrer bar 1420 includes a main body 1422 comprising at least one recess that accepts at least one magnet therein. In the illustrated embodiment, first and second opposed recesses 1424, 1426 receive two magnets 1428, 1430 therein and a cover 1432 is secured in any suitable fashion atop the main body 1422, such as by cap screws 1434 that are threaded into threaded recesses 1436, to capture the magnets 1428, 1430 in the recesses 1424, 1426, respectively. The cover 1432 and the main body 1422 include aligned central bores 1440 and 1442, respectively, that receive the reduced diameter portion 1418 therethrough such that the stirrer bar 1420 is rotatably captured between the shoulder 1419 and an upwardly-extending boss 1444 disposed on the upper surface 1412 of the base 1406 wherein the stirrer bar 1420 sits atop the boss 1444 in contact therewith.

Upper and lower internally threaded ends 1446, 1447 (visible in FIG. 6) of the central rod 1412 extend upwardly and downwardly relative to the cover 1406 and the bottom plate 1404, respectively, and suitable fastening apparatus 1448, 1449, such as bolts, cap screws, machine screws, and the like with optional washers sealingly engage the threaded ends and/or the cover 1404 and base 1406 with the main member 1402 therebetween in sealing contact with the O-rings 1410, 1412 to maintain the elements of the ink container 1400 (i.e., the main member 1402, the cover 1404, the base 1406, and the central rod 1414 with the stirrer bar 1420 thereon) in assembled relationship. The upper plate comprising the cover 1404 and the lower plate comprising the base 1406 are thus secured to upper and lower portions of the main member 1402 and the central rod 1414 extends through the upper plate comprising the cover 1404 and is preferably sealingly fixed thereto in any suitable fashion.

An inlet tube 1450 and an outlet tube 1452 extend through opposed bores 1454, 1456, respectively, in the cover 1404 into the space within the main member 1402 to an extent just short of the cover 1432. The inlet tube 1450 and the outlet tube 1452 are sealingly engaged to the cover 1404 within the bores 1454 and 1456, respectively, and upper ends of the tubes 1450, 1452 include inlet and outlet couplers 1460, 1462, respectively, that are adapted to sealingly couple the tubes 1450, 1452 to fluid conduits (not seen in FIGS. 2-6). A pressure controlled port 1464 receives controlled pressures from the controller 110 and is included in the cover 1404 and a further coupler 1466 is provided to sealingly couple the port to a further fluid conduit 1467 (shown in FIG. 3) that is fluidically selectively coupled to one of the conduits 1360, 1362 of FIG. 1 as appropriate to control the pressure in the container 1400 for proper operation. Specifically, when the container 1400 comprises one of the first reservoirs 1306, the ink control 100 maintains a vacuum applied to the port 1464 at a controlled level whereas when the container 1400 comprises one of the second reservoirs, the ink control 100 pressurizes the container 1400 or vents the container 1400 through the port 1464. While the main member 1402 is illustrated in FIGS. 3 and 4 as being transparent, in an embodiment, the main member is made of an opaque material (such as steel or plastic). In such embodiment, a transparent sight tube 1470 is sealingly coupled outside the main member 1402 in fluid communication between a lower portion of the space within the main member 1402 and an upper portion of the space within the main member 1402. The level of ink in the ink container 1400 is indicated by the level of ink in the sight tube 1470.

Referring specifically to FIGS. 2-6 and 18, in use, the ink container 1400 is disposed on the holder 1403 and a variable speed motor 1480 is mounted in any suitable manner below the container 1400 and two magnets 1482, 1484 are disposed in stir housing 1485 and secured to a shaft 1486 of the motor 1480. The motor 1480 is controlled by a controller, such as the controller 110, to rotate at a limited speed to cause the two magnets 1482, 1484 to rotate about the central axis of the motor shaft 1486. The magnets 1482, 1484 are arranged with opposite magnetic polarities facing up whereas the magnets 1428, 1430 are arranged with opposite magnet polarities facing down. Further the structures located between the magnets 1428, 1430 on the one hand and the magnets 1482, 1484 on the other hand are magnetically permeable and the strengths of the magnets 1428, 1430, 1482, 1484 and the spacing therebetween are such that rotation of the magnets 1482 and 1484 induces rotation of the stirrer bar 1420 in the ink container 1400. Disposition of the stirrer bar 1420 on the central rod 1414 between the shoulder 1419 and the upwardly-extending boss 1444 rotatably captures the stirrer bar 1420 and keeps the stirrer bar 1420 stable during rotation. Preferably, the stirrer bar 1420 only rests on the boss 1444 so that there is no contact of the stirrer bar 1420 with the remainder of the upper surface 1412 of the base 1406 so that friction is reduced. In some embodiments, one or both of the boss 1444 and/or the bottom surface of the stirrer bar includes one or more upwardly-extending portion(s) and/or downwardly-extending portion(s), respectively, of limited extent so that contact between the stirrer bar 1420 and the boss 1444 is minimized and friction is reduced. Friction is further reduced due to the fact that the ink acts like a lubricant. Rotation of the stirrer bar 1420 in this fashion agitates the ink in the ink container 1400 so that particles (e.g., pigments, colorants) in the ink remain in suspension and do not settle.

Also in use, the ink in the ink container 1400 is drawn from the bottom portion thereof, through the fluid outlet tube 1452, through the outlet coupler 1462, and delivered to a component of the ink supply unit 1300 via a fluid line. Such drawing of ink causes fluid to be drawn through the inlet coupler 1460 and the inlet tube 1450 into the bottom portion of the ink container 1400 where the ink is promptly stirred by the stirrer bar 1420. Preferably, the lower ends of the inlet tube 1450 and outlet tube 1452 are beveled to reduce turbulence that may otherwise lead to adverse ink effects. In the case of the container 1400 comprising one of the first reservoirs 1306, air is supplied to the port 1464 of the container 1400 at a controlled pressure during such time to allow the movement of ink from the container 1400 yet still maintain the vacuum therein. When the container comprises the second reservoir 1308, air at a controlled positive relative pressure or at ambient or other pressure is supplied to the port 1464 to facilitate ink movement. In either case, the stirrer bar 1420 and associated apparatus are sealingly contained within the container 1400, thus obviating the need specialty dynamic seals.

In some embodiments, such as shown schematically in FIG. 8, the stirrer bar 1420 is suspended solely by the central rod 1414 a predetermined distance away from the upper surface 1412 of the base 1406, in which case the boss 1444 is not needed and may be omitted. In such embodiment, the stirrer bar 1420 may be rotatably suspended by the central rod 1414, such as by one or more bearings, rings, collars, sleeves, snap rings, and/or other apparatus, as should be evident to one of ordinary skill in the art. Suspending the stirrer bar 1420 away from the upper surface 1412 prevents friction between a bottom surface of the stirrer bar 1420 and the upper surface 1412.

In other embodiments, the stirrer bar 1420 includes a recessed portion 1488 (FIG. 11) and a projecting member, such as a boss 1490, extends upwardly into the recessed portion 1488. In such embodiment, an upper surface 1492 defining the recessed portion 1488 rests upon the boss 1490 and the stirrer bar 1420 is rotatably captured between the shoulder 1419 and the boss 1490. As in the embodiment of FIGS. 2-6, one or more upwardly-extending or downwardly extending portions may be provided on the upper surface of the boss 1490 and/or the surface 1492 to reduce friction.

In embodiments, securing the stirrer bar 1420 using the central rod 1414 ensures that the stirrer bar 1420 is located at a known position within the container 1400 and does not become displaced during use. Otherwise, the stirrer bar may become displaced (e.g., cocked) and/or when the ink bottle is opaque, the position of the magnetic stirrer bar 1420 may not be readily determined.

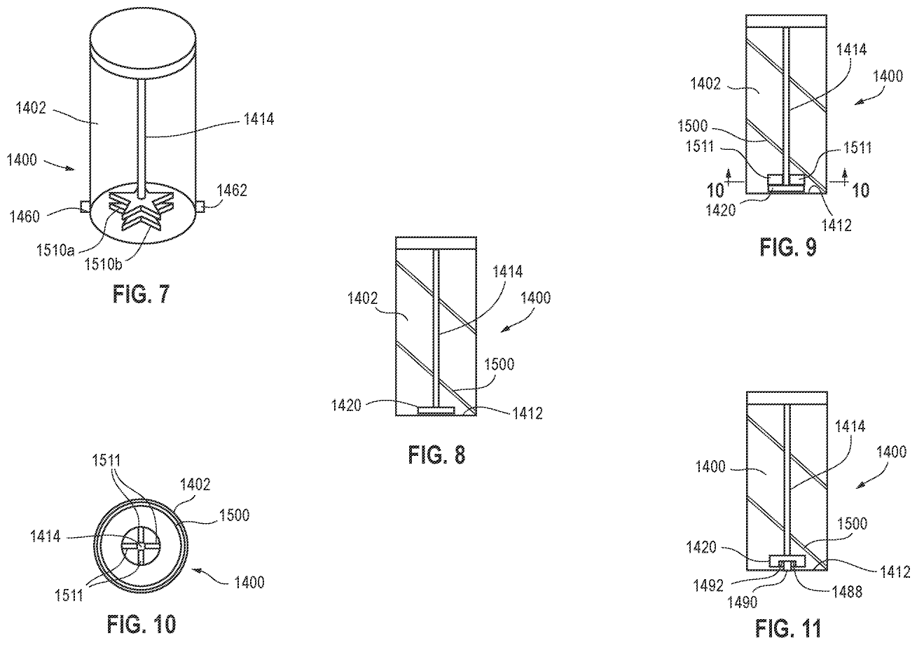

If desired, one or both of the inlet tube 1450 and outlet tube 1452, and/or any other elements, may instead be located at different locations and be shaped and/or dimensioned differently than as shown in FIGS. 2-6, e.g., as exemplified by a comparison of FIGS. 2-6 with FIG. 15. In an embodiment, the inlet and outlet tubes 1450 and 1452 are omitted and the inlet and outlet couplers are used alone at the base of the container 1400 or at least no higher than the minimum level of ink in the container 1400 to introduce ink into and allow fluid flow out of the ink container 1400. Thus, for example, as seen schematically in FIG. 7, the inlet tube 1450 and outlet tubes 1452 are omitted and the couplers 1460, 1462 are located diametrically opposite one another near or at the lower end of the bottom portion of the ink container 1400. In addition or alternatively, as seen schematically in FIG. 8, one or more bumps or protrusions, such as one or more inwardly-extending spiral protrusions 1500, may be provided on an inside surface 1502 of the main member 1402 to maximize mixing.

Still further, while the stirrer bar 1420 is racetrack-shaped, any number of any-shaped stirrer bars may instead be used, such as the multiple star-shaped stirrer bars 1510a, 1510b, as desired. In an embodiment, at least one magnet is disposed in or on one or both of the stirrer bars 1510a, 1510b, as in the previously-described embodiment(s). Thus, for example, the lower stirrer bar 1510b may be of sufficient thickness and may be hollow to accept one or more magnets therein. In an embodiment, the multiple stirrer bars 1510 rotate about the central rod 1414. In certain embodiments, one or more stirrer bars, such as the stirrer bars 1510, rotate with the central rod 1414.

In an embodiment, portions of one or more stirrer bars themselves are magnetized, thereby obviating the need for separate magnets. Still further, one or more upwardly and/or downwardly (i.e., axially) extending projections 1511 (FIGS. 9 and 10) may be provided on one or more stirrer bars. The main member 1402 and the lower plate comprising the base 1406 may be replaced in an embodiment by a cup-shaped main member 1512 such as seen in FIGS. 8 and 9, as should be evident to one of ordinary skill in the art.

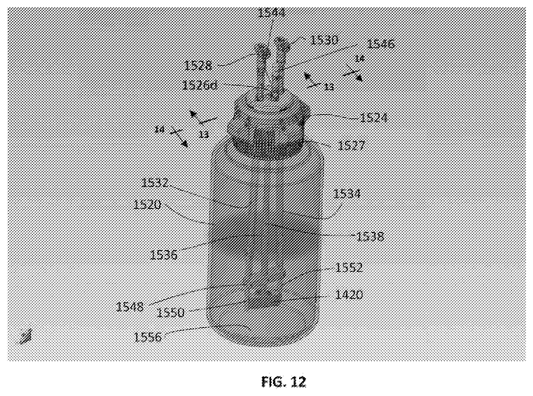

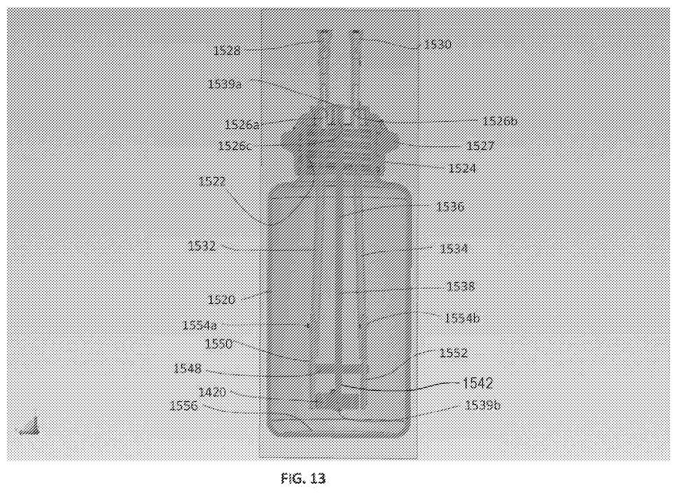

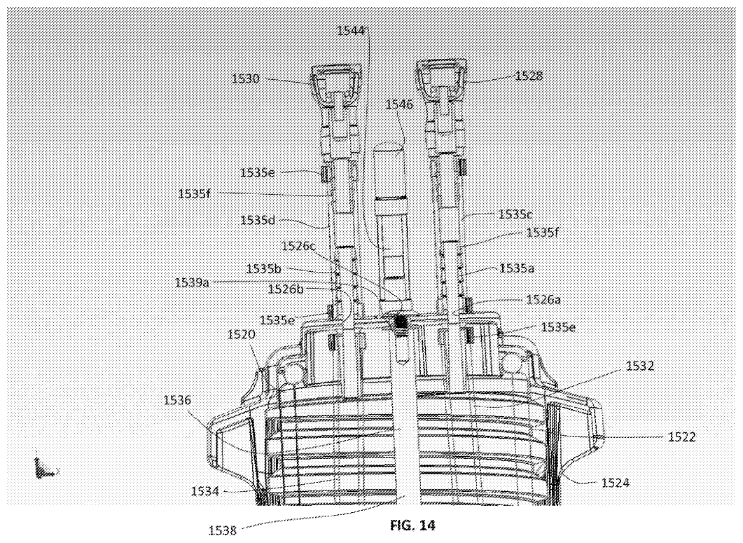

At times, containers sold by one or more vendors do not have a flat bottom. The bottom may be dome-shaped or have other irregularities that make it difficult to use in a system that utilizes a stir bar. FIGS. 12-14 illustrate an embodiment of such a container, which may comprise the reservoir 1302 of FIG. 1. The reservoir 1302 includes a raised center portion on a bottom surface and therefore is an example of a container that does not have a flat bottom. This container style benefits particularly from the use of a suspended stir bar such as that disclosed herein, since a traditional magnetic stir bar rides on the bottom of the container, and on a container such as this the stir bar will easily fall to the side, which would prevent it from coupling itself to the magnetic drive under the bottle.

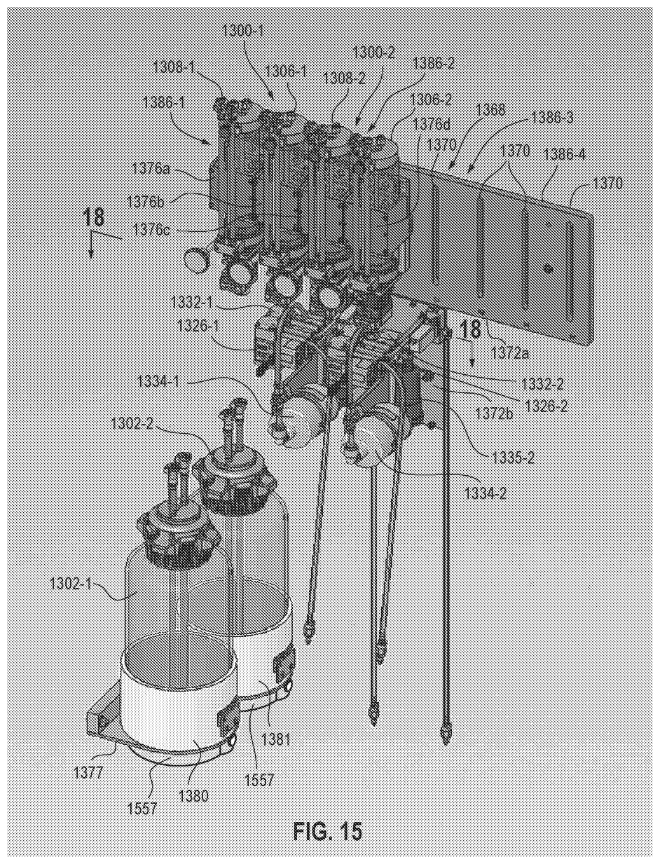

The reservoir 1302 comprises a cup-shaped main member 1520 having an upper threaded portion 1522 (visible in FIGS. 13 and 14) that receives a cover in the form of a threaded cap 1524. The cap 1524 includes bores 1526a, 1526b, 1526c, and 1526d (1526d is indicated in FIG. 12) that extend therethrough and an outer portion 1527 that is knurled and/or formed with one or more protrusions that facilitate gripping by a user.

Inlet and outlet couplers 1528, 1530, respectively, are coupled to fluid inlet and outlet tubes 1532, 1534, in any suitable fashion. With specific reference to FIG. 14, in the illustrated exemplary embodiment, rigid tube sections 1535a, 1535b sealingly extend through the bores 1526a, 1526b, respectively, into the main member 1520 and further tube sections 1535c, 1535d couple upper ends of the rigid tube sections 1535a, 1535b to lower ends of the inlet and outlet couplers 1528, 1530, respectively. Lower ends of the rigid tube sections 1535a, 1535b are coupled to upper ends of the inlet and outlet tubes 1532, 1534, respectively. Circumferential spring clips (such as indicated as 1535e) may secure the various elements in assembled relationship. The tube sections 1535c, 1535d may be flexible, as may the inlet and outlet tubes 1532, 1534, although some or all of such tubes may be rigid. Further, one or both ends of the rigid tube sections 1535a, 1535b and lower ends of the inlet and outlet couplers 1528, 1530 may include ridged portions, for example, as indicated as 1535f, to assist in maintaining a sealed relationship with the inlet and outlet couplers 1528, 1530, respectively.

Referring again to FIGS. 12-14, a stationary central rod 1536 extends through the bore 1526c and is carried by the cap 1524 and extends into the main member 1520. The central rod 1536 comprises a central portion 1538, upper and lower internally threaded ends 1539a, 1539b, respectively, (both visible in FIG. 13) disposed on either side of the central portion 1538, and a reduced diameter portion defined by a shoulder 1542 disposed between the central portion 1538 and the lower end. The central rod 1536 is sealingly secured in any suitable manner within the bore 1526c and one or more fasteners, such as a cap screw with optional washer, extends into the internally threaded end 1539a to fix the central rod 1536 to the cap 1524. In an embodiment, an air filter 1546 (FIGS. 12 and 14) permits air to enter the reservoir 1308. Alternatively or in addition, a pressure controlled port like the port 1464 sealingly extends through the bore 1526d in the cap 1524 and a further coupler (not shown) is provided to sealingly couple the port 1544 to a further fluid conduit (not shown) and thence to the ink control 100. In this case, the ink control 100 controls whether the reservoir 1308 is vented.

As in the embodiments of FIGS. 7-10, the central rod 1536 is suspended in the embodiment of FIGS. 12-14 solely by the cover, which, in the illustrated embodiment, comprises the cap 1524. With specific reference to FIGS. 12 and 13, a support member 1548 is secured in any suitable fashion to the central rod 1536 inside the main member 1520 between the upper and lower ends 1539a and 1539b. A pair of spaced rigid tubes 1550, 1552 is carried by the support member 1548 at opposite ends thereof. Upper ends of the rigid tubes 1550, 1552 receive lower ends of the inlet and outlet tubes 1532, 1534, respectively, with further resilient circumferential spring clips 1554a, 1554b that secure the latter about the former in sealed relationship. Lower ends of the rigid tubes 1550, 1552 extend toward a lower inner surface 1556 of the main member 1520. As in other embodiments, the stirrer bar 1420 is rotatably secured to the lower end 1539b of the central rod 1536 between the shoulder 1542 and one or more bearings, rings, collars, sleeves, snap rings, and/or other apparatus, as should be evident to one of ordinary skill in the art that are disposed at or adjacent the lower end 1539b.

Although not visible, rotatable magnets identical or similar to the magnets 1482, 1484 are disposed in stir housings, such as seen only in FIG. 15 at 1557, below each of the restraining members 1380, 1381, 1384, and 1385 and rotation of such magnets induces rotation of the stirrer bar 1420, as in other embodiments, so that ink in the main member 1520 is agitated as previously described. Also in use, ink in the member 1520 is drawn from the bottom portion thereof, through the fluid outlet tube 1534, through the outlet coupler 1530, and delivered to a component of the ink supply unit 1300 via a fluid line. During operation the vent 1544 is open to allow air into the member1520. Such drawing of ink causes fluid to be drawn through the inlet coupler 1528 and the inlet tube 1532 into the bottom portion of the main member 1520 where the ink is promptly stirred by the stirrer bar 1420. If desired, the lower ends of the tubes 1550, 1552 may be beveled to reduce turbulence that may otherwise lead to adverse ink effects.

Each of the stir housings may comprise an IKA 3671000 Magnetic stirrer sold by Sycamore Life Sciences of Houston, Texas.

An advantage of a stirring mechanism such as shown in FIGS. 12-14 is that, with the addition of a seal washer to the screw 1539a, the whole mechanism can be sealed in the reservoir 1302. This provides advantages, such as the ability to pressure control the reservoir 1302 without the need for specialty dynamic seals, as compared to, for example, the case where the ink is directly stirred from the top with a motor and shaft extending into the fluid.

It may be noted that any of the reservoirs 1302, 1306, and/or 1308 may be implemented by any of the embodiments of FIGS. 2-14, if desired. Also, any of the agitation/stirring components may be omitted from the reservoir(s) 1302, 1306, and/or 1308, if desired.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### INDUSTRIAL APPLICABILITY

In summary, the modular nature of the physical arrangement of ink supply units in a housing facilitates use of the ink supply units in varying installations. Further, embodiments of the reservoirs disclosed herein encounter minimal friction in use and each stirrer bar is disposed at a fixed location and orientation within the reservoir so that ink agitation is uniform.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the embodiments (especially in the context of the following claims) are to be construed to cover both the singular and the plural, unless otherwise indicated herein or clearly contradicted by context. Recitation of ranges of values (i.e. amounts) herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure. Unless otherwise noted, all recitations of weight percentages are with reference to a unit weight of the printing composition as a whole.

Numerous modifications to the present disclosure will be apparent to those skilled in the art in view of the foregoing description. It should be understood that the illustrated embodiments are exemplary only and should not be taken as limiting the scope of the disclosure.

We claim:

1. A fluid container, comprising:
a main member;
upper and lower plates secured to upper and lower portions of the main member, respectively;
a central rod extending through the upper plate;
a hollow stirrer bar rotatably coupled to the central rod and disposed in a space between the upper and lower plates;
at least one first magnet disposed in the stirrer bar;
an inlet tube and an outlet tube extending into the main member; and
a holder disposed outside of the space between the upper and lower plates; and
at least one movable second magnet magnetically linked with the at least one first magnet, wherein movement of the at least one second magnet causes rotation of the stirrer bar.

2. The fluid container of claim 1, wherein the hollow stirrer bar is racetrack shaped.

3. The fluid container of claim 1, wherein the stirrer bar does not contact the upper plate or the lower plate.

4. The fluid container of claim 1, wherein the stirrer bar is captured between a shoulder of the central rod and a boss.

5. The fluid container of claim 1, in combination with a housing in which the fluid container is disposed.

6. The fluid container of claim 1, wherein the fluid container comprises a first ink reservoir and further including a second ink reservoir identical to the first ink reservoir wherein the first ink reservoir and the second ink reservoir are coupled to an ink control and an inkjet printhead.

7. The fluid container of claim 6, wherein the first ink reservoir and the second ink reservoir are mounted in first and second slots of a mounting plate disposed in a housing.

8. The fluid container of claim 7, wherein the mounting plate includes further slots adapted to receive further ink reservoirs.

9. A modular ink assembly, comprising:
a first mounting plate having a plurality of mounting stations each adapted to receive and mount a plurality of fluid containers at variable relative elevations;
first and second ink reservoirs mounted at one of the mounting stations;
a second mounting plate adjacent the first mounting plate and adapted to receive and mount ink supply elements; and
a plurality of restraining members disposed adjacent the mounting stations wherein each restraining member is adapted to receive a main supply reservoir.

10. The modular ink assembly of claim 9, further including an ink supply reservoir disposed in one of the restraining members.

11. The modular ink assembly of claim 9, wherein the ink supply elements comprise at least one pump mounted on the second mounting plate.

12. The modular ink assembly of claim 11, wherein the ink supply elements further comprise a filter and a degas module mounted on the second mounting plate.

13. The modular ink assembly of claim 9, wherein the first mounting plate and the second mounting plate are disposed in a housing.

14. The modular ink assembly of claim 9, wherein each of the first and second ink reservoirs comprises a container having an agitation apparatus therein.

15. The modular ink assembly of claim 14, wherein the first plate and the second plate comprise an upper plate and a lower plate and wherein the agitation apparatus comprises a central rod extending through the upper plate of the container, a hollow stirrer bar rotatably coupled to the central rod and disposed in a space between the upper plate and the lower plate and at least one first magnet disposed in the stirrer bar.

16. The modular ink assembly of claim 15, further comprising a holder disposed outside of the space between the upper and lower plates and at least one movable second magnet magnetically linked with the at least one first magnet, wherein movement of the at least one second magnet causes rotation of the stirrer bar.

17. The modular ink assembly of claim 10, wherein the ink supply reservoir comprises a container having an agitation apparatus therein.

18. The modular ink assembly of claim 17, wherein the agitation apparatus comprises a central rod extending through a cap of the container, a hollow stirrer bar rotatably coupled to the central rod and disposed in a cup-shaped member of the container, and at least one first magnet disposed in the stirrer bar.

19. The modular ink assembly of claim 18, further comprising a restraining member disposed about the cup-shaped member and at least one movable second magnet magnetically linked with the at least one first magnet, wherein movement of the at least one second magnet causes rotation of the stirrer bar.

20. The modular ink assembly of claim 9, wherein each mounting station comprises a pair of slots.
